(19) United States
(12) Patent Application Publication
(10) Pub. No.: US 2024/0419785 A1
(43) Pub. Date: Dec. 19, 2024

(54) BEHAVIOR DETECTION WITH DETECTION REFINEMENT FOR DETERMINATION OF EMERGING THREATS

(71) Applicant: Arm Limited, Cambridge (GB)

(72) Inventors: Michael BARTLING, Austin, TX (US); Brendan James MORAN, Coton (GB)

(21) Appl. No.: 18/211,392

(22) Filed: Jun. 19, 2023

(51) Int. Cl. G06F 21/55; G06F 21/57

(52) U.S. Cl. CPC G06F 21/552; G06F 21/554; G06F 21/577

(57) ABSTRACT

A method includes receiving precursor alerts from a precursor detector that detects events from a processing unit, wherein each precursor alert comprises information of an event from the processing unit, the information of an event from the processing unit, detecting a first event in the precursor alerts indicating undesirable behavior and including a first score that is above a first value, setting a first timer for a first period of time, accumulating a score update with the first score of the first event. Upon the score update reaching or exceeding a first threshold value within the first period of time, generating a refined alert.

### BACKGROUND

In conventional computers and computer networks, an attack refers to various attempts to achieve unauthorized access to technological resources. An attacker may attempt to access data, functions, or other restricted areas of a susceptible computing system without authorization. For example, the attacker may attempt to steal sensitive data, corrupt parts of the susceptible computing system, which may appear benign in nature, or to overwhelm public operations by forcing these operations to be called excessively. Thus, an attacker can use many types of attacks with different goals in mind to attack a technological resource. Many times, the attacker tries new and different attack strategies to achieve these goals such that the type of attack may be novel. In this case, the defender has not had the opportunity to prepare a defense against the novel type of attack. A method and/or system to detect and adapt to emerging threats can therefore be useful.

A behavior source in a computing system can be used as a source of system telemetry events. The behavior source can be a variety of computing system components such as, but not exclusively, a CPU core, cache, memory controller, and bus monitors. For example, Central Processing Units (CPUs) with performance monitoring capability such as a performance monitoring unit (PMU) have the capacity to produce detailed information about the operations performed by the CPU. This detailed information is typically tracked in terms of ‘events’, which are the result of processor execution. From these events, i.e., system telemetry events, one can infer higher level software behaviors enabling a defender or trusted party of the computing system to detect evidence of an attack to the computing system and, potentially, to detect the attack as it is happening.

### BRIEF SUMMARY

Methods and systems that utilize behavior detectors to detect emerging threats are provided. The behavior detectors detect emerging threats by determining how two or more events are related. A refinement detection processor generates refined alerts in response to the detected emerging threat.

A method includes receiving precursor alerts from a precursor detector that detects events from a processing unit, wherein each precursor alert comprises information of an event from the processing unit, the information of an event from the processing unit, detecting a first event in the precursor alerts indicating undesirable behavior and including a first score that is above a first value, setting a first timer for a first period of time, accumulating a score update with the first score of the first event. In some cases, upon the score update reaching or exceeding a first threshold value within the first period of time, generating a refined alert. In other cases, upon the score update reaching or exceeding a first threshold value within the first period of time, providing the score update to a second accumulator, setting a second timer for a second period of time, detecting a second event in the precursor alerts indicating undesirable behavior and including a second score that is above a second value, accumulating, by the second accumulator, the score update with scores of detected second events during the second period of time. Upon the score update reaching or exceeding a second threshold value within the second period of time, generating the refined alert.

A detector includes a refinement detection processor coupled to receive precursor alerts from a precursor detector, the refinement detection processor having instructions to receive precursor alerts from a precursor detector that detects events from a processing unit, wherein each precursor alert comprises information of an event from the processing unit, the information of an event from the processing unit, detect a first event in the precursor alerts indicating undesirable behavior and including a first score that is above a first value, set a first timer for a first period of time, accumulate a score update with the first score of the first event. In some cases, upon the score update reaching or exceeding a first threshold value within the first period of time, the detector generates a refined alert.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example operating environment for behavior detection with detection refinement.

FIG. 2 illustrates an example detection refinement process.

FIG. 3 illustrates a schematic diagram of a precursor detector classifying events in accordance with one embodiment.

FIG. 4 illustrates an operating environment for a system-level behavior detection with detection refinement.

FIG. 5 illustrates a method in accordance with one embodiment.

FIG. 6 illustrates an example of a modeling engine.

### DETAILED DESCRIPTION

A method of behavior detection with detection refinement for the determination of emerging threats is provided. The method determines an emerging threat by correlating at least two events within a period of time. A refinement detection processor generates a refined alert in response to the determined emerging threat.

Typically, when an attacker attacks a processing unit, a sequence of actions (resulting in software events) is performed within a period of time to accomplish the attack. Emerging threats occur when the sequence of actions includes particular actions that haven't been seen before in an attack and aren't completely understood. However, when there are at least a couple of actions in the sequence of actions known to be and/or highly suspected of being malicious, an attack is more likely to have occurred or is occurring. Thus, when other actions in the sequence deviate from what has been seen before by the processing unit but includes the at least two known or highly suspected malicious actions, the sequence of action as a whole can be considered to be a likely attack or an emerging threat. The unknown actions in the sequence of actions can then be considered suspicious, and in some cases, declared as malicious.

Behavior of a circuit such as a processor or other device, including the success of commands or particular operations, can be represented as an event or sequence of events in an event stream. The event stream, describing software behaviors resulting from actions taken by a user, for example, within a window of time can be evaluated. Events can come from a variety of sources or may be derived from combinations of existing sources. Thus, as stated previously, even when some of the software behaviors (depicted by software events) in the sequence are unknown, as compared to behaviors known to occur during of an attack, the sequence of software behaviors as a whole can be reasoned on to determine if an attack or undesirable behavior has occurred.

Undesirable software behaviors can be categorized into at least two different types, software weakness exploits and generic undesirable behaviors. A software weakness can be a flaw in the software that gives an attacker access to exploit the software for malicious purposes. One simple example of a software weakness is when a buffer in the software with a fixed size is not checked before the buffer is written to. In this example, the buffer can easily be overwritten allowing the attacker to interact with nearby, yet out of bounds memory. Software weaknesses, however, are fairly well defined and understood by both attackers and defenders. Thus, new software weaknesses rarely emerge over time. An exploit of a software weakness, e.g., a software weakness exploit, may be seen in the event stream describing software behaviors. Generic undesirable behaviors can encompass all other undesirable behaviors seen in the event stream.

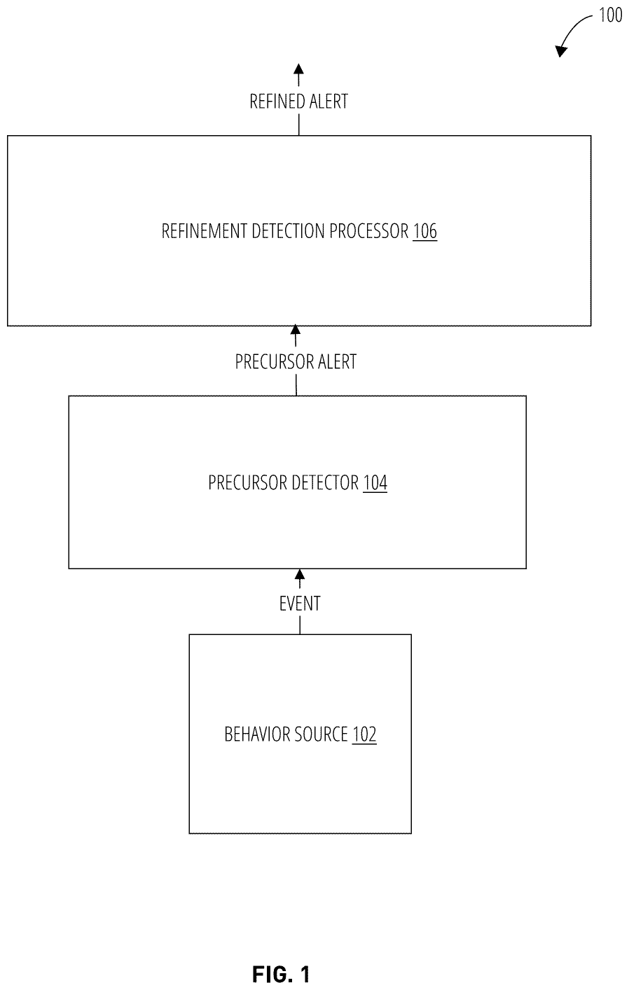

FIG. 1 illustrates an example operating environment for behavior detection with detection refinement. Referring to FIG. 1, operating environment 100 includes a behavior source 102, a precursor detector 104, and a refinement detection processor 106.

The behavior source 102 e.g., a source of events, emits events that describe software behaviors. Behavior source 102 can be a processing unit. The processing unit can be, but is not limited to, a CPU core, graphics processing unit (GPU), microcontroller, or computing unit (e.g., multiplier-accumulator (MAC) unit with memory). Similarly, it should be understood that the precursor detector (e.g., precursor detector 104) can receive events from (and be used to create consumable events from) other sources such as, but not limited to, memory controllers, cache controllers, bus interface units (e.g., PCLs), network interface controllers, mixed signal blocks (e.g., used for radio interface), and digital filters.

In some cases, the behavior source 102 is a CPU core that includes a memory and a PMU. The behavior source 102, e.g., CPU core, can execute commands/instructions stored in the memory. As commands/instructions are performed, certain activities, operations, and behaviors at the behavior source 102 and its interfaces may be considered events. The events may be collected and/or aggregated in the PMU.

The behavior source 102 can be coupled to a precursor detector 104. The precursor detector (e.g., part of the circuitry of the processing unit or separate circuitry) is used to monitor for events from the behavior source 102 that may indicate an undesirable behavior, attack, or even an inefficiency at the processing unit. For example, in the scenario of a processing unit of a CPU core with a PMU, precursor detector 104 can be configured to receive an event stream of events from the PMU (directly in an aggregate form or in some form of consumable event) and generate precursor alerts when undesirable behaviors are encountered. In some cases, the behavior source 102 can be communicatively coupled to multiple precursor detectors 104.

The event stream of events can, for example, be a bit stream produced by the PMU that monitors and records actions of the behavior source 102. These PMU events can describe issues that occur during execution of commands from the behavior source 102. The event can include, but are not limited to, branch mis-predict, load retired, store retired, branch retired, and cache miss. Events can also be 1-bit information or multi-bit signals (e.g., 2-bits, 3-bits).

In some cases, the precursor detector 104 can be a classifier that processes events of the event stream to create classified events. The classified event can be stored in storage or immediately used by another system or device, such as by refinement detection processor 106. The precursor detector 104 is able to produce consumable events from the classified events that can maintain temporal information and the order of events, which benefits a variety of applications. In some cases, the precursor detector 104 takes in a window of events or samples, transforms the features into a consumable form, e.g., a consumable event, and then identifies which predefined categories the window may belong to, or be composed of.

A consumable event refers to an event corresponding to or associated with behaviors of a processing unit or other circuit and is consumable because it is information that is in a format that can be consumed/used by another device, circuit, or system. The particular format of a consumable event can vary. The consumable form can include the event, e.g., the behavior associated with the event, and a score indicating a confidence level of the prediction to the predefined categories the event may belong to or be composed of. For example, the probability or likelihood an event belongs to a particular category/categories.

In some cases, the undesirable behaviors described by the events can be known malicious behaviors. The known malicious behaviors are behaviors that have been previously classified as malicious. Known malicious behaviors can have corresponding high scores. In other words, the classifier has a high confidence level that the event describes a malicious behavior. In other cases, the undesirable behaviors described by the events can be suspicious. These events are classified as an event indicating an undesirable behavior but can include lower scores. For example, the event can indicate a malicious behavior but since the corresponding score is relatively lower, the undesirable behavior is suspicious. Unknown behaviors are behaviors that have not been previously classified.

Precursor detectors, however, can be inherently noisy, creating precursor alerts for patterns detected that may not be associated with an attack or undesirable behavior. Thus, precursor detectors can sometimes produce faulty data, such as generating a false positive, e.g., a sample erroneously matching as an undesirable event. Referring back to FIG. 1, precursor detector 104 produces precursor alerts which can then be sent to refinement detection processor 106 for further refinement.

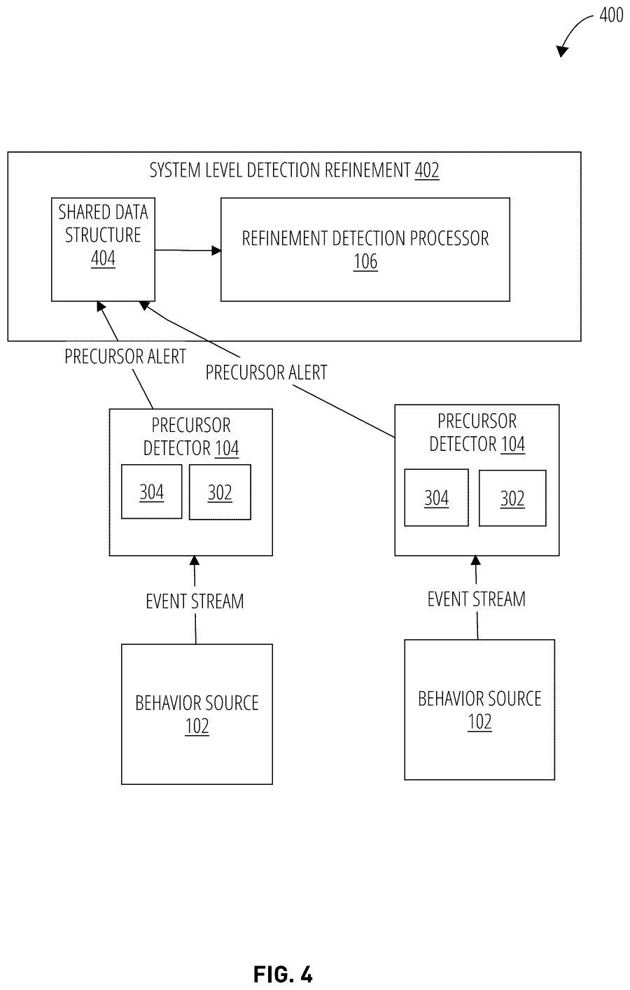

Refinement detection processor 106 can receive the precursor alerts from precursor detector 104. While one precursor detector 104 is illustrated in FIG. 1, in some cases, refinement detection processor 106 can receive precursor alerts from more than one precursor detector 104 such as illustrated in FIG. 4. When the refinement detection processor 106 receives precursor alerts from more than one precursor detector 104, the refinement detection processor 106 can be a system-level detector. The refinement detection processor 106 performs further analysis on the information received in the precursor alerts and generates refined alerts when the analysis indicates that an undesirable behavior or attack has occurred. With the further refinement that the refinement detection processor 106 provides, the refined alerts can be received with a higher confidence level than those produced by the precursor detectors 104. These refined alerts can then be used by further applications to take responsive action, for example.

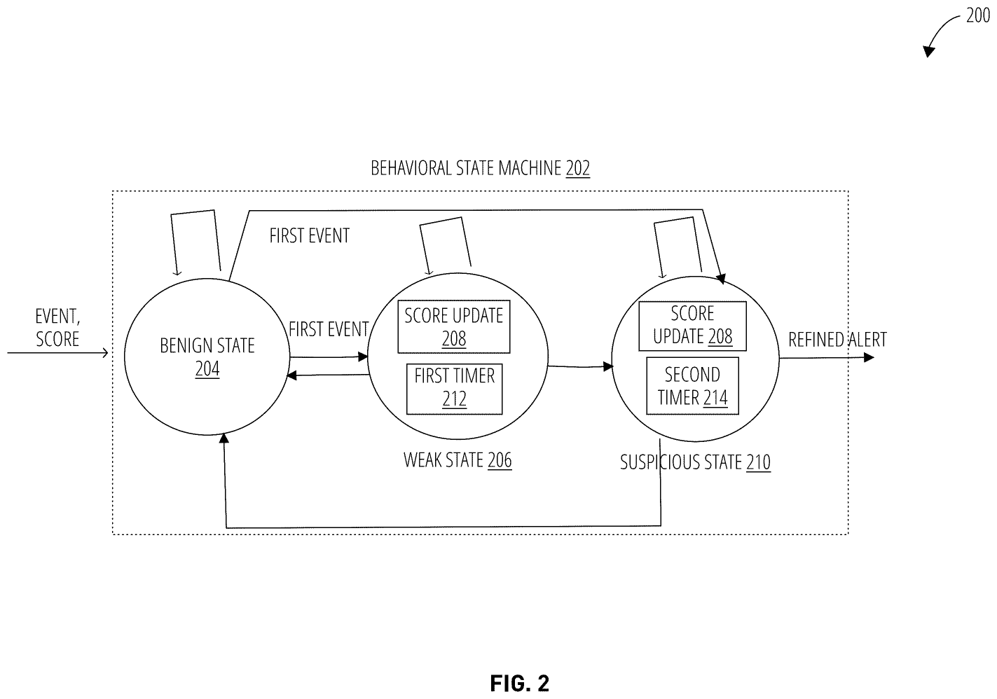

In some cases, refinement detection processor 106 can be implemented using a counter-based state machine with a timeout after a period of time. An example of a refinement detection process using a state machine is illustrated in FIG. 2. In other cases, refinement detection processor 106 can be implemented using a ring buffer with timeout after the period of time.

FIG. 2 illustrates an example behavior detection refinement process. The example behavior detection refinement process 200 can be described using a state machine, e.g., behavioral state machine 202, as shown. Precursor alerts including information such as the event and score are received by the behavioral state machine 202.

The behavioral state machine 202 begins operation in a benign state 204 such that no precursor alerts have been received. In some cases, precursor alerts, are received by the behavioral state machine 202, but the behaviors described by the events are considered benign such that the state remains in the benign state 204 (shown by arrow originating and terminating in benign state 204). In some cases, the event shows a suspicious behavior, but the associated score is below a threshold, such that the state remains in the benign state.

A first event is detected indicating undesirable behavior and including a score that is above a first value. In a first embodiment, the first event indicates a software weakness exploit with an associated score above a first value such that the state is changed to the weak state 206. In a second embodiment, the first event indicates a malicious behavior and a first score above the first value such that the state is changed to the suspicious state 210.

In the first embodiment, once the first event is detected indicating a software weakness exploit with a score above the first value and the state is changed to the weak state 206, a first timer is started for a first period of time. A first accumulator updates a score update 208 with the first score. The score update is utilized in the behavioral state machine 202 to build confidence in each state. In some cases, the score update is a cumulative algebraic evaluation of the scores.

The behavioral state machine 202 continues receiving events describing behaviors in the weak state 206. In some cases, the events are considered benign such that the state remains in the weak state 206 (shown by arrow originating and terminating in weak state 206). In other cases, the events indicate an undesirable behavior, such as a software weakness exploit. The first accumulator updates the score update from each event indicating the undesirable behavior with the associated first score when the first score is above a first value.

When the score update 208 reaches or exceeds a first threshold value, the state is changed to the suspicious state 210 and a second timer 214 is set for a second period of time. In some cases, if the first timer 212 times out after the first period of time while in the weak state 206, the state is changed back to the benign state 204. Additionally, after the first timer 212 times out, the first timer 212 and the score update 208 are reset to zero.

Once in the suspicious state 210, a second event can be detected indicating undesirable behavior and including a second score. The score update is updated by a second accumulator with the corresponding score of the second event. The behavioral state machine 202 continues receiving second events describing behaviors. Upon the score update 208 reaching or exceeding a second threshold value, the behavioral state machine 202 determines that there is an emerging threat. A refined alert is issued. The generated refined alert can include stored event information with associated scores and any contextual information for further analysis.

In some cases, in the suspicious state 210, events are considered benign such that the state remains in suspicious state 210 (as shown by arrow originating and terminating in suspicious state 210). In other cases, the events indicate an undesirable behavior, the associated score is below a threshold, such that the state remains in suspicious state 210. These events can be considered suspicious and saved. In some cases, if the second timer 214 times out in the suspicious state 210, the state is changed back to the benign state 204. Additionally, if the second timer 214 times out in the suspicious state 210, the second timer 214 and the score update 208 are reset to zero.

If the first event is detected indicating a malicious behavior with a score above a first value, the state is changed to the suspicious state 210 and the second timer 214 is started for the second period of time. A second accumulator updates the score update 208 with the score. The behavioral state machine 202 continues receiving events describing behaviors. In some cases, the events are considered benign such that the state remains in the suspicious state 210 (shown by arrow originating and terminating in the suspicious state 210). In other cases, the events indicate an undesirable behavior, but the associated score is below a threshold, such that the state remains in the suspicious state 210. These events can be considered suspicious and saved.

In some cases, the event indicates an undesirable behavior and the associated score is above a value. The second accumulator updates the score update 208 with the score. When the score update 208 reaches or exceeds a second threshold value, e.g., after receiving one or more undesirable behaviors with scores above a second threshold value, a refined alert can be generated. The generated refined alert can include stored event information with associated scores and any contextual information for further analysis. In some cases, if the second timer times out after the second period of time while in the suspicious state 210, the state is changed back to the benign state 204. Additionally, after the second timer times out, the second timer 214 and the score update 208 are reset to zero.

In some cases, performing each accumulator, e.g., first accumulator/second accumulator, update can be based on the score and the predefined category the event belongs to. More specifically, performing each accumulator update is accomplished by a linear combination of the score and a category weight and adding that linear combination to the accumulator. For example, all benign categories could include a category weight of 0.5 while malicious categories can be 0.75. Then, the score for a given window of events is a dot product of the vector of scores, e.g., confidence levels, and the category weights. Alternately, the score for the window can use a weight calculation function that can change the score for that category non-linearly based on the confidence level of that category. In some cases, the score can be computed with a neural network using multiple linear combinations of the output scores of the classifier. In other cases, the score update 208 can be a simple counter counting events.

As a simple example, a first event indicates a buffer has overflowed, e.g., a software weakness exploit, with a first score above a first value such that the probability is high that this event, e.g., buffer overflow, has occurred. The state on the behavioral state machine 202 is changed to the weak state 206. In the weak state 206, an unknown behavior is detected with a score below a threshold value. The unknown event along with its score is stored. The score update 208 is not updated. The state remains the weak state 206. Next, an event indicates that a jump is made into the buffer, e.g., a suspicious event, and the score is above a threshold. The score and the event are saved and the first accumulator updates the score update with the score. The state is changed to the suspicious state 210 and the score update is provided to the second accumulator. The first timer 212 is stopped and the second timer 214 is started. Finally, another event is detected that indicates that an instruction has been executed from the buffer, e.g., a malicious event. Again, the score and the event are saved and the second accumulator updates the score update with the score. Because the event is classified as a malicious behavior its associated score will be relatively high. The score update reaches or exceeds a threshold value and a refined alert is generated. The score update and the timers are reset to zero and the state is changed back to the benign state.

While behavioral state machine 202 has been used to illustrate an example behavior detection refinement process, other implementations are also possible. For example, rather than having specified rules, such as those utilized by behavioral state machine 202, a neural network can be used to examine the current state and input data log and emit state transition logic.

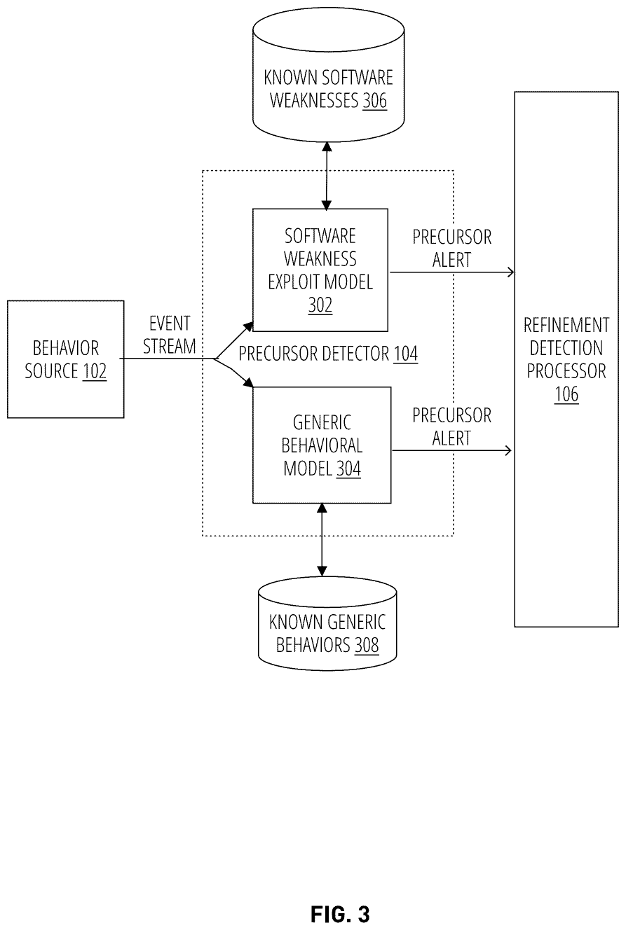

FIG. 3 illustrates a schematic diagram of a precursor detector classifying events. In the embodiment shown in FIG. 3, the precursor detector 104 is a classifier performing real time classification. In the shown embodiment, precursor detector 104 includes two models, a software weakness exploit model 302 and a generic behavioral model 304. Both models can be contained within precursor detector 104, as shown in FIG. 3. Alternately, each model can be contained within a respective precursor detector as shown in FIG. 4. Both the generic behavioral model 304 and the software weakness exploit model 302 can run near or on the behavior source 102. Generic behavioral model 304 and software weakness exploit model 302 receive the event stream emitted by behavior source 102 to determine when an undesirable behavior has occurred.

The software weakness exploit model 302 uses the event stream to determine that a software weakness exploit has occurred by identifying symptoms of known software weaknesses. The generic behavioral model 304 uses the event stream to determine that an undesirable behavior, e.g., unknown, suspicious, or malicious, has occurred.

In some cases, the generic behavioral model 304 and software weakness exploit model 302 are generated using machine learning (ML) models implemented with neural networks or deep learning techniques. For example, in some cases, the precursor detectors 104 implemented as classifiers can use the ML models to classify data such as events. In other cases, the precursor detectors 104 implemented as anomaly detectors can use the ML models to determine when data, such as an event, diverges from normal.

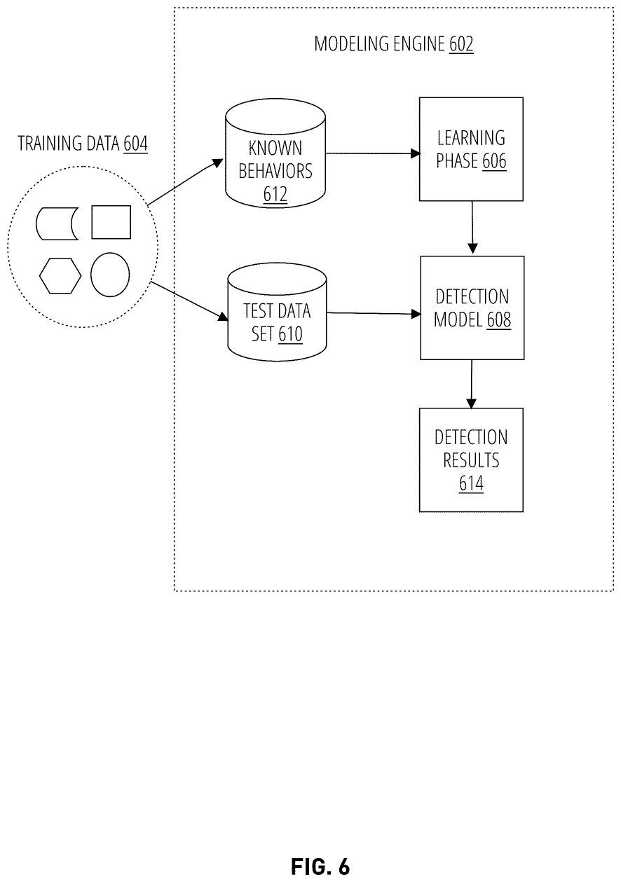

In some cases, utilizing an ML modeling engine, as shown in FIG. 6, the software weakness exploit model 302, can be trained with training data to detect software weakness exploits using a data set of known software weaknesses 306. As stated above, software weaknesses are fairly well defined and understood by both attackers and defenders. Thus, new software weaknesses rarely emerge over time. For this reason, software weakness exploit model 302 can be considered effectively fixed so that updated training need not occur or occurs infrequently. In addition, because the software weakness exploit model 302 can be considered effectively fixed, the precursor alerts generated by the software weakness exploit model 302 can be received with a high confidence level and will generally have high scores.

In some cases, utilizing an ML modeling engine, the generic behavioral model 304 can be trained with training data to detect generic behaviors using a data set of known generic behaviors 308. As stated previously, behavior of a circuit such as a processor or other device, including the success of commands or particular operations can be represented as a sequence of events in the event stream. These events, describing software behaviors, can be classified for reasoning on whether the behavior falls within a range of acceptable behavior or is an undesirable behavior. Software behaviors are highly variable and can change over time and it is unlikely that a model will be trained on all possible behaviors. Thus, predicting an undesirable software behavior is sometimes difficult for a trained model to detect. In some cases, when the generic behavioral model 304 is a classifier used to classify data, the determination of the score is relative to a training data set of the predefined categories. While a quantified classification measure has been used as an example, the score can also include a prediction probability, log likelihood estimate, distance to category, etc. The classified event along with the score extracted from the event stream by the precursor detector 104 form a consumable event.

If an undesirable behavior has been detected by the generic behavioral model 304 or the software weakness exploit model 302, respectively, a precursor alert can be sent out, for use by other applications, such as by refinement detection processor 106. The precursor alert includes the consumable event, e.g., event and score.

FIG. 4 illustrates an operating environment for system-level behavior detection with detection refinement. Referring to FIG. 4, an operating environment for system-level behavior detection 400 can include system level detection refinement 402 receiving precursor alerts from two precursor detectors 104. While two precursor detectors 104 have been shown for illustrative purposes, system level detection refinement 402 can detect precursor alerts from more than two precursor detectors 104. Each precursor detector 104 includes a generic behavioral model 304 and a software weakness exploit model 302 receiving an event stream of data from a corresponding behavior source 102. The generic behavioral model 304 and the software weakness exploit model 302 each create consumable events and send out precursor alerts when these consumable events include undesirable behaviors. The precursor detectors 104 and refinement detection processor 106 can be as described with reference to FIG. 1.

In some cases, the refinement detection processor 106 can include a shared data structure 404 and a refinement detection processor 106. Shared data structure 404 can include registers and/or other storage devices. Shared data structure 404 receives and stores the precursor alerts from each precursor detector 104. Refinement detection processor 106 is coupled to the shared data structure 404 to receive the precursor alert from each of the precursor detectors 104. In the case that the refinement detection processor 106 receives precursor alerts from multiple precursor detectors 104, the information of the event can include a timing relationship of the event. The refinement detection processor 106 orders the precursor alerts according to the timing relationship of the event. The refinement detection processor 106 orders, or reorders, the precursor alerts in the shared data structure 404 to maintain temporal coherency so that a sequence of events can logically make sense when interpreting the sequence of events to define undesirable behaviors or an attack.

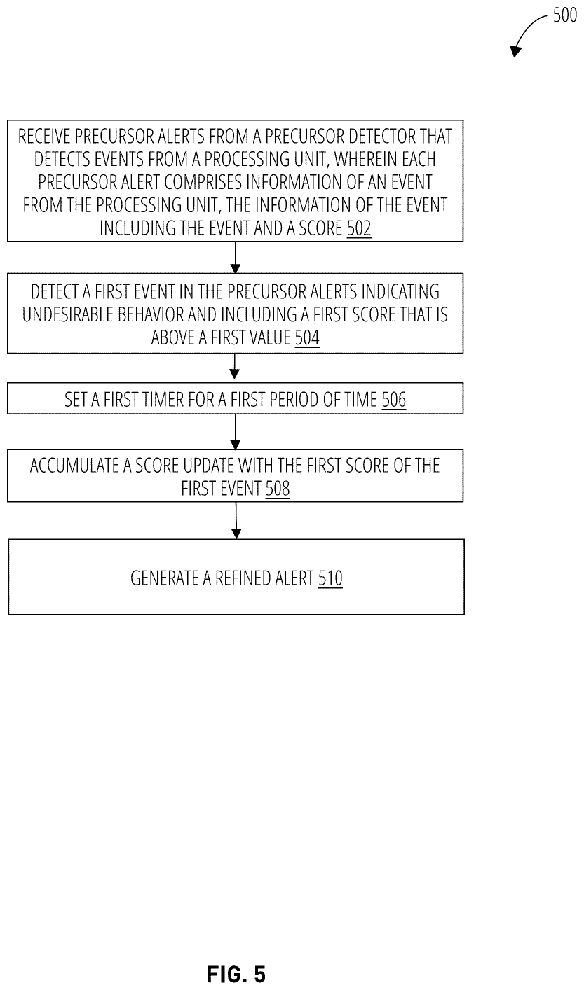

FIG. 5 illustrates a method in accordance with one embodiment. Method 500 can be performed by a computing system supporting a refinement detection processor 106 as described by FIG. 1. The method correlates at least two events indicating undesirable behaviors within a period of time. The at least two events each have a score over a certain value indicating a high probability that the event has been classified correctly as an undesirable event. The method can account for a sequence of events including unknown events or merely suspicious events in the sequence, however, as long as at least two events in the sequence indicate undesirable behaviors with high confidence, an alert can be sent for further evaluation or to take a responsive action.

Referring to FIG. 5, method 500 receives (502) precursor alerts from a precursor detector that detect events from a processing unit, wherein each precursor alert comprises information of an event from the processing unit, the information of the event including the event and a score. Method 500 detects (504) a first event in the precursor alerts indicating an undesirable behavior and including a first score above a first value. Method 500 sets (506) a first timer for a first period of time. Method 500 accumulates (508) a score update with the first score of the first event in a first accumulator. Upon the score update reaching or exceeding a first threshold within the first period of time, method 500, generates (510) a refined alert.

After receiving (502) each precursor alert, the refinement detection processor 106 checks the information of the event for the event describing a behavior and the score. Once the refinement detection processor 106 detects (504) a first event from the precursor alerts that indicates an undesirable behavior and the first event includes a first score above a first value, a first timer is set (506) for a first period of time. The first accumulator accumulates (508) a score update with the first score of the first event. After detecting the first event indicating an undesirable behavior and including a score above the first value, the information of the event, including the first event and the first score, as well as a value of the score update can be stored for further evaluation. For each additional first event that indicates an undesirable behavior with a score above the first value, the score update is updated with the first score. In some cases, when the score update reaches or exceeds a first threshold value within the first period of time, the score update, a refined alert is generated (510).

In some cases, when the score update reaches or exceeds a first threshold value within the first period of time, the score update is provided to a second accumulator and a second timer 214 is set. Once the first timer 212 times out, it is reset to zero. provides the score update to a second accumulator and sets a second timer for a second period of time. Method 500 detects a second event indicating an undesirable behavior and including a score that is above a second value. Method 500 accumulates the score update with scores of detected second events during the second period of time in the second accumulator. Upon the second threshold counter reaching or exceeding a second threshold value within the second period of time, method 500 generates (510) a refined alert.

When the second accumulator reaches or exceeds a second threshold value, the refinement detection processor 106 can correlate the two events to indicate an attack or an emerging threat and generates a refined alert. The first threshold value and the second threshold value can each be set to a value to represent a sensitivity to the state of the refinement detection processor 106. For example, in a common attack chain, e.g., sequence, called “shareware”, after a localized exploit has been accomplished, an attacker may attempt to encrypt the target's data and hold it for ransom. In sequence, this process is suspicious, whereas encryption in isolation is not. The values for the score after the first score may be lower than the first value of the first score because once a first undesirable behavior is detected, one may have more confidence that a second undesirable behavior in the period of time will indicate an attack.

In some cases, after the refined alert is generated, the stored information including the stored events in the sequence of events including the first event and the second event and those events in between can be analyzed. For any events describing suspicious or unknown behaviors, the suspicious or unknown behavior can be provided to a data set for training utilizing the ML model to produce an updated data set of known generic behaviors. The generic behavioral model 304 can be updated with the updated training data set of known generic behaviors.

FIG. 6 illustrates an example of a modeling engine 602 that could be used to create and train the respective high-level ML model for the software weakness exploit model 302 or the generic behavioral model 304. In some cases, modeling engine 602 can receive training data 604, such as known behaviors in the case of the generic behavioral model 304, from one or more sources, to be used as a training data set in a learning phase 606 to generate an initial model. In other cases, modeling engine 602 can receive training data 604, such as known software weaknesses, from one or more sources, to be used as a training data set in the learning phase 606 to generate an initial model. The learning phase 606 can feed the initial model to the detection model 608, which takes in a test data set 610 to generate detection results 614. The learning phase 606 can include one or more methodologies of machine learning, including deep learning or use of various neural networks. Using the detection model 608, the outputs of the learning phase 606 can be compared against the test data set 610 to determine the accuracy of the model trained in the learning phase 606. The process can continue until a high-level model with a desired accuracy is attained.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method, comprising:
receiving precursor alerts from a precursor detector that detects events from a processing unit, wherein each precursor alert comprises information of an event from the processing unit, the information of the event including the event and a score;
detecting a first event in the precursor alerts indicating undesirable behavior and including a first score that is above a first value;
responsive to detecting the first event:
setting a first timer for a first period of time;
accumulating, by a first accumulator, a score update with the first score of the first event;
upon the score update reaching or exceeding a first threshold value within the first period of time:
generating a refined alert.

2. The method of claim 1, further comprising:
upon the score update reaching or exceeding a first threshold value with the first period of time:
providing the score update to a second accumulator;
setting a second timer for a second period of time;
detecting a second event in the precursor alerts indicating undesirable behavior and including a second score that is above a second value;
accumulating, by the second accumulator, the score update with scores of detected second events during the second period of time;
upon the score update reaching or exceeding a second threshold value within the second period of time:
generating the refined alert.

3. The method of claim 1, further comprising after detecting the first event in the precursor alerts indicating undesirable behavior and including a first score above the first value, storing the information of the event.

4. The method of claim 1, wherein the first event indicates a malicious behavior.

5. The method of claim 1, wherein the first event indicates a software weakness exploit.

6. The method of claim 1, wherein the precursor detector is a classifier.

7. The method of claim 6, wherein the precursor detector includes a software weakness exploit model that receives the events from the processing unit to detect first events that indicate software weakness exploits and wherein the precursor detector further includes a generic behavioral model that receives events from the processing unit to detect first events that indicate suspicious, unknown, or malicious behaviors.

8. The method of claim 7, wherein the software weakness exploit model and the generic behavioral model are each generated using a machine learning (ML) model implemented with neural networks or deep learning techniques.

9. The method of claim 8, further comprising, after generating the refined alert, providing the suspicious behavior to a data set for training utilizing the machine learning model to produce an updated data set of known generic behaviors.

10. The method of claim 7, further comprising updating the generic behavioral model with the updated training data set of known generic behaviors.

11. The method of claim 10, further comprising, after generating the refined alert, providing the unknown behavior to a data set for training utilizing the machine learning model to produce an updated data set of known generic behaviors.

12. The method of claim 1, wherein the precursor detector is an anomaly detector.

13. The method of claim 8, further comprising multiple precursor detectors, each precursor detector including the respective software weakness exploit model and the generic behavioral model that receives events from a respective processing unit.

14. The method of claim 2, wherein the accumulating, by the first accumulator and the second accumulator, respectively, is accomplished by a linear combination of the score and a category weight and adding the linear combination to the respective accumulated score update.

15. A detector, comprising:
a refinement detection processor coupled to receive precursor alerts from a precursor detector, the refinement detection processor having instructions to:
receive precursor alerts from the precursor detector that detect events from a processing unit, wherein each precursor alert comprises information of an event from the processing unit, the information of the event including the event and a score;
detect a first event indicating an undesirable behavior and including a first score above a first value;
set a first timer for a first period of time;
accumulate, by a first accumulator, a score update with the first score of the first event;
upon the score update reaching or exceeding a first threshold value within the first period of time:
generate a refined alert.

16. The detector of claim 15, wherein the refinement detection processor further having instructions to:
upon the score update reaching or exceeding a first threshold value within the first period of time:
provide the score update to a second accumulator;
set a second timer for a second period of time;
detect a second event in the precursor alerts indicating undesirable behavior and including a second score that is above a second value;
accumulate, by the second accumulator, the score update with scores of detected second events during the second period of time;
upon the score update reaching or exceeding a second threshold value within the second period of time:
generate the refined alert.

17. The detector of claim 15, wherein the precursor detector is a classifier performing real time classification.

18. The detector of claim 15, wherein the refinement detection processor is communicatively coupled to multiple precursor detectors, each precursor detector coupled to a corresponding processing unit.

19. The detector of claim 18, wherein each of the multiple precursor detectors includes a generic behavioral model and a software weakness exploit model.

20. The detector of claim 15, wherein the refinement detection processor comprises a state machine, the state machine is used to determine emerging threats.
